(19) United States
(12) Patent Application Publication
(10) Pub. No.: US 2020/0097605 A1
(43) Pub. Date: Mar. 26, 2020

(54) MACHINE LEARNING TECHNIQUES FOR AUTOMATIC VALIDATION OF EVENTS

(71) Applicant: Microsoft Technology Licensing, LLC, Redmond, WA (US)

(72) Inventors: Jingyuan Liu, Jersey City, NJ (US); Xiaoqiang Luo, Cos Cob, CT (US); Tzu Ming Kuo, Long Island City, NJ (US); Marcello Oliva, New York, NY (US); Yunpeng Xu, Millburn, NJ (US)

(21) Appl. No.: 16/141,853

(22) Filed: Sep. 25, 2018

(51) Int. Cl. G06F 17/30; G06N 99/00

(52) U.S. Cl. CPC G06F 17/30864; G06N 99/005

(57) ABSTRACT

A system and method are provided for automatic identification, extraction, and validation of data pertaining to receiving entity events (REE). Feature (or attribute) values associated with web content are identified. The web content may contain news and features on current/past affairs. The identified feature values are considered by a rule-based or a machine-learned model and, based upon output of the model, a determination as to whether the set of data comprises a REE is made. If the determination is positive, then multiple data items are extracted from the set of data and, optionally, from other data from the source.

### TECHNICAL FIELD

The present disclosure relates to machine learning and, more particularly to, generating machine-learned models to identify, extract, and validate information pertaining to certain types of events.

### BACKGROUND

Digital journalism has provided a contemporary medium for news stories and articles shared via the Internet that allows for distribution of news and features on current affairs at an unprecedented rate. Because of this influx of news content, it is physically impossible for one to manually filter through all of this content in order to generate specific metrics and analytics. In particular, traditional methods of extracting and validating specific news content requires a reader to physically read the news article, manually determine what in the news content is of importance, and refer to another source in order to determine the validity of the news content.

Development of tools, such as machine learning, reduces the amount of time and resources utilized by users, and allows computers to progressively improve performance on a specific task. Accordingly, information can be extracted from massive quantities of documents and web content available on the internet. However, utilizing these tools still require users to manually use specific searches and parameters in order to filter specific information within the web content.

Companies and organizations spend countless hours attempting to generate metrics and analytics pertaining to document and web content in order to advance practices and generate strategies. In particular, significant events, such as mergers and acquisitions, can serve as signals for entities to perform actions such as recruiting more talent or expanding operations. However, some companies currently rely on manually filtering through the massive quantities of documents and web content in order to identify and extract details about these significant events. Other companies might query an expensive third-party source that relies on manual data entry about such events.

What is needed is a method for automated extraction of details of these significant events from various sources, and validation of the resulting information extracted from the various sources.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is an example system in which the techniques described may be practiced according to certain embodiments;

FIG. 2 is a block diagram that depicts a process for extracting and validating event information, in an embodiment;

FIG. 3 is a block diagram that depicts an example extracting and validation system for event information, in an embodiment;

FIG. 4 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method are provided for automatic identification, extraction, and validation of data pertaining to receiving entity events (REE). Feature (or attribute) values associated with web content are identified. The web content may contain news and features on current/past affairs. The identified feature values are considered by a rule-based or a machine-learned model and, based upon output of the model, a determination as to whether the set of data comprises a REE is made. If the determination is positive, then multiple data items are extracted from the set of data and, optionally, from other data from the source.

An examination may be performed to verify whether the REE has already been added to a network inventory or server, for example, from another source. The examination may be performed by a rule-based model or a machine-learned model. REEs are mapped to unique identifiers associated with the receiving entities indicated in the source. If a version of the REE already exists in the inventory, then a comparison and, possibly, and aggregation of multiple versions of the REE are performed, and the highest quality version of the REE is stored in the inventory and the remaining versions are deleted or stored as redundant entries if necessary. If a version of the REE does not already exist in the inventory, then the receiving entity of the REE is mapped to a unique identifier or generates a unique identifier for the REE to map to. The mapping of the entity and REE to the unique identifier may be performed by a rule-based model or a machine-learned model.

If the model is a machine-learned model, then one or more machine-learning techniques are used to “learn” weights of different features, which weights are then used in determining if the set of data contains a REE. In one embodiment, the model is non-parametric and contains no weight. After the mapping process, a validation process occurs in which the respective outputs of the data identification, data extraction, entity identification, and REE determination are checked for accuracy. The extracted REE is transformed into a specific format and stored in the network inventory.

As described herein, a source may include but is not limited to an online newspaper, news blog, or any other digital media content providing reports, stories, articles, news titles, and announcements. News information may include but is not limited to the substantive web content or data/metadata within a media content source.

The systems and methods described herein provide improvements to identification, extraction, and validation of data pertaining to receiving entity events (REE). By using a rule-based model or a machine-learned model to generate feature values of text portions of web content, an analysis is performed on the feature values, and classification of whether the web content contains a REE is based on the analysis. By automated identification, extraction, and validation of REEs within web content, the system is able to provide users with a scalable method to collect, process, and validate specific content within mass quantities of documents that would have previously required countless hours of manual labor. Furthermore, the systems and methods provide automated elimination of duplicate or redundant data along with reliable data authentication by aggregating and validating receiving entity events from multiple sources. Thus, the systems and methods described herein improve the functioning of computing systems by optimizing big data processing via automated identification, extraction, and validation of web content that accommodates users of networks with large quantities of media.

### Example System

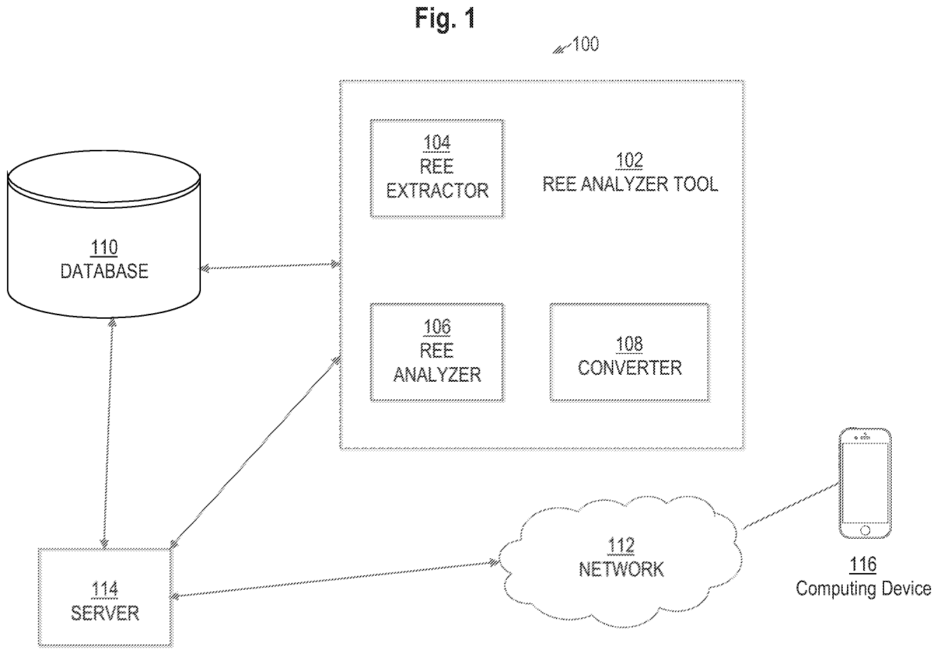

FIG. 1 illustrates an example system 100 in which the techniques described may be practiced according to certain embodiments. System 100 is a computer-based system. The various components of system 100 are implemented at least partially by hardware at one or more computing devices, such as one or more hardware processors executing instructions stored in one or more memories for performing various functions described herein. For example, descriptions of various components (or modules) as described in this application may be interpreted by one of skill in the art as providing pseudocode, an informal high-level description of one or more computer structures. The descriptions of the components may be converted into software code, including code executable by an electronic processor. System 100 illustrates only one of many possible arrangements of components configured to perform the functionality described herein. Other arrangements may include fewer or different components, and the division of work between the components may vary depending on the arrangement.

FIG. 1 is an example system for automated identifying, extracting, and validating a REE, in an embodiment. As described herein, receiving entity events (REE) include any news article, story, blog, or any other news media digital content that pertains to funding, fundraising, donating, charity, endowments, gifts, investments, or bequests given or received.

System 100 includes a REE analyzer tool 102 that interacts with database 110 and server 114. Database 110 comprises multiple content items from one or more web sources. Example content items include news articles, news videos, and other media content containing extractable information that may be provided (e.g., continuously) by third party content providers via push or pull mechanisms. In an embodiment, the content items may be sourced from any other components of system 100, such as network 112, or sources outside of system 100.

Server 114 communicates data produced by REE analyzer tool 102 across network 112, which interact with computing device 116. Server 114 may be embodied by one or more server computers, cloud-based computers, cloud-based cluster of computers, virtual machine instances or virtual machine computing elements such as virtual processors, storage and memory, data centers, storage devices, desktop computers, laptop computers, mobile devices, computer network devices such as gateways, modems, routers, access points, switches, hubs, firewalls, and/or any other special-purpose computing devices. REE analyzer tool 102 comprises REE extractor 104, REE analyzer 106, and converter 108. REE analyzer tool 102 may also include additional various modules and tools to perform detection, analysis, and extraction of certain types of events reflected in content items stored in database 110, such as a binary classifier used to determine whether extracted content indicates an REE. Content items within database 110 may be from any source, including but not limited to, internet browsing service, digital file, or news service platforms comprising extractable data and metadata such as text fields, audio transcripts, and video transcripts.

In an embodiment, content items within database 110 are traversed text portion by text portion (e.g., phrase by phrase or sentence by sentence) in order to determine whether the text portion indicates an REE. Upon a determination by the binary classifier that the text portion indicates an REE, REE extractor 104 extracts data within the text portion. REE extractor 104 may use machine-learned models, regular expressions, delimiters, or any other formal language.

Although only a single database 110, server 114, and computing device 116 are depicted, system 100 may include multiple servers and databases that interact with network 112 and that provide services to multiple computing devices both within and outside of system 100. Examples of computing devices include a laptop computer, a tablet computer, a smartphone, a desktop computer, a Personal Digital Assistant (PDA), and any other mechanism used to access the internet or applications. An example of an application includes a dedicated application that is installed and executed on computing device 116 and that is configured to communicate with server 114 over network 112. Another example of an application is a web application that is downloaded from server 114 and that executes within a web browser executing on a computing device. Server 114 may be implemented in hardware, software, or a combination of hardware and software. Network 112 may be implemented as a Local Area Network (LAN), Wide Area Network (WAN), Ethernet or the Internet, one or more terrestrial, satellite or wireless links, or any medium or mechanism that provides for the exchange of data between REE analyzer tool 102, database 110, server 114, and computing device 116.

### Receiving Entity Event Analyzer Tool

REE analyzer tool 102 performs extraction of data items from a text portion via REE extractor 104, content analysis via REE analyzer 106, and conversion of the extracted content to a REE in a specific format to be stored in an entity database as a REE record via converter 108. REE analyzer tool 102 may perform natural language processing (NLP) and logical reasoning inferences based on context and content within the text portion and, optionally, surrounding content.

### Sources for REE Consideration

Multiple attributes or features may be considered when classifying text portions of web content as an REE. Example features for REE classification include:
a. news article title: The recognizing of n-grams comprising certain words, characters, or phrases within the text or solely in the title of the article. For example, an article where the title reads “Microsoft invested $100 million in LinkedIn subsidiary FictionalCo” will be identified as a REE due solely to the recognizable n-gram “invested $100 million”, the currency symbol, and investor.
b. news article content: The recognizing of n-grams comprising certain words, characters, or phrases within the text of the body of the article. For example, an article that contains in the body “Later this year, Microsoft will invest $100 million to LinkedIn subsidiary FictionalCo” will be identified as a REE and have an extractable receiving entity, FictionalCo, and monetary amount, $100 million.
c. Stock Symbols: Stock-based identifiers assigned to a security traded on a particular market or allocated symbols for specific entities associated with a stock exchange. These symbols may be updated or changed to reflect mergers and acquisitions.
d. Email Address: The email address based on the domain associated with the web content comprising the news article.
e. news article publication date: The exact date the article is published, the ingestion date, or date provided in the URL of the article.
f. context data: Information that is retrievable via attributes of the article content, such as, but not limited to principal place of business of the receiving entity, geolocation of publishing news source, industry pertaining to article topic, and URL links provided within the article. For example, an article posted in the Silicon Valley Business Journal that reads “On Monday, Microsoft invested $100 million in LinkedIn subsidiary FictionalCo” will be identified as a REE and have an extractable receiving entity, monetary amount, industry (technology), and location (Silicon Valley, Calif.).
g. Quantity: The amount associated with the REE that may be reflected by currency, transfer of real or personal property, or any other metric that indicates an exchange between two entities.
h. Round Type: Venture round for capital. For example, whether the REE involved seed capital, Series A funding, Series B funding, or Series C funding.

### Rule-Based Classification Model

Classifying a REE within web content may be performed in a number of ways. For example, rules may be established that weigh certain attributes of data within a text portion of web content, and combine the weighted attribute values to generate an output (e.g., a single value) that is used to determine whether the text portion of web content contains an REE. Rules may be determined manually.

In an embodiment, a token string is fed into a classification model that generates, as output, a score that indicates whether the token string comprises or indicates an REE.

A rule-based classification model has numerous disadvantages. One disadvantage is that it fails to capture nonlinear correlations. Another issue with a rule-based model used for video classification is that the hand-selection of values is error-prone, time consuming, and non-probabilistic. Hand-selection also allows for bias from potentially mistaken business logic. A third disadvantage is that output of a rule-based model is an unbounded positive or negative value. The output of a rule-based model does not intuitively map to a classification. In contrast, machine learning methods are probabilistic and therefore can give intuitive classifications.

### Machine-Learned Classification Model

In an embodiment, a classification model is generated based on training data using one or more machine learning techniques. Machine learning is the study and construction of algorithms that can learn from, and make predictions on, data. Such algorithms operate by building a model from inputs in order to make data-driven predictions or decisions. Thus, a machine learning technique is used to generate a statistical that is trained based on a history of attribute values associated with metadata, content items, and other data extracted from text portions. The machine-learned model is trained based on multiple attributes (or factors) described herein. In machine learning parlance, such attributes are referred to as “features.”

In an embodiment, various feature weights or coefficients are established to accurately classify one or more text strings within web content as containing an REE based on feature values. The weights may be determined by machine learning techniques such as training a regression model using feature values. The logistic regression model is used to determine whether the text identified from the text portion is an REE. Extracted text may include text fields pertaining to investors, investees, investment date, investment amount, round type, and other obtainable information within web content. Text fields within web content contain tokens such as characters, symbols, and strings; which are used to determine whether a text field indicates a certain type of event. Upon affirmation via output of the model that indicates a REE, multiple data items are extracted from the text portion, such as an investor name, investee name, investment date, investment amount, and round type. The tf-idf of the unigrams, bigrams, and n-grams within the text fields are entered into model, and the extracted text may be a character, string, Boolean value, integer, or other unit.

In an embodiment, the classification model comprises a plurality of decision trees that are trained using one or more machine learning techniques that include a gradient boosting technique and a pruning technique utilizing classification and regression.

To generate and train a machine-learned model, a set of features is specified and training data is generated. The set of features dictates how data that REE analyzer tool 102 collects is processed in order to generate the training data. In an embodiment, a new machine-learned model is generated regularly, such as every month, week, or other time period. Thus, the new machine-learned model may replace a previous machine-learned model. Newly acquired or changed training data may be used to update the model. For example, additional training data may be used to re-train the model in order to produce a better REE classification.

### Example Classification Process

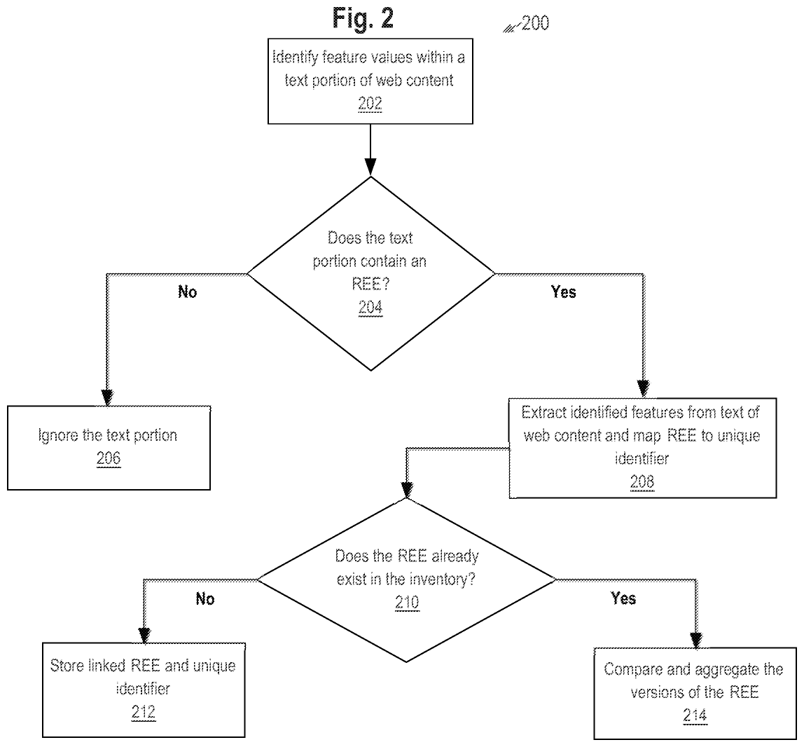

FIG. 2 is a block diagram that depicts process 200 for automatically identifying, extracting, and validating an REE, in an embodiment. Prior to process 200, a binary classification model is trained based on multiple training instances using one or more machine learning techniques. At block 202, REE analyzer tool 102 uses REE analyzer 106 to traverse a content item text portion by text portion to identify multiple feature values. Example features include the tf-idf for unigrams, bigrams, and/or n-grams, characters and specific words/phrases/symbols within the text portion. REE analyzer tool 102 may simply traverse a title or other relevant portion of web content in order to identify the necessary feature values for a REE. The tf-idf corresponding to unigrams, bigrams, and n-grams within a text portion (e.g., title, sentence, phrase) of a content item are inserted into the trained classification model.

In an embodiment, feature values are derived from the determination as to whether any distinguishing strings, symbols, and characters pertaining to investors, investees, investment date, quantity of the amount pertaining to the investment, stock symbols, and round type are present within web content. For example, if the content item is an article entitled “Microsoft invests $50 million into NewStartUpCo”, then distinguishing strings, symbols, and characters within the article such as “invests”, “$”, “Microsoft”, and “NewStartUpCo” may be identified in the title and the training model is leveraged to reflect that these strings, symbols, and characters are in the title of the article.

In an embodiment, system 100 utilizes one or more additional machine-learning models that are trained via content within server 114 or another computing system (not depicted). These additional machine-learning models may be used to integrate pre-existing extractable content within server 114, such as receiving entity names that are mapped to an existing unique entity identifier.

At block 204, a determination is made as to whether a text portion within web content contains an REE based on the output of the classification model. If it is determined that the text portion contains an REE, then, at block 208, REE extractor 104 extracts data items from the text portion. Otherwise, at block 206, the text portion is ignored. After block 206, process 200 may return to block 202 where another text portion within the content item is considered or a text portion within other content item is considered. REE analyzer tool 102 may be configured to continuously analyze content items provided to database 110, which may be continuously updated with content from one or more third-party content sources, such as news sources.

Converter 108 converts the extracted text into a specific format, and REE analyzer tool 102 exports the REE in a specific format file as a REE record to server 114 or a database configured to store entities and communicate over network 112. Stored REE records may be accessed and utilized by computing device 116 via an application or other graphical user interface. If it is determined that the text portion does not contain a REE, then that text portion is ignored. Process 200 may return to block 202 where another text portion within the web content is considered or where a text portion of different web content (e.g., a different online article) is considered.

In an embodiment, a candidate set of unique identifiers is assigned to receiving entities (investees) and investors. In order to avoid duplicate records for entities that have the same or similar names, each receiving entity is associated with a unique identifier that belongs to a particular entity. In order to account for aliases and subsidiaries, it is possible for an entity to have a set of unique identifiers associated with it. The unique identifiers may be used as a key value for a specific schema associating all the extractable field values configured to be pushed to database 110 for real time querying. The mapping of a receiving entity to a unique identifier may be performed by a rule-based model or a machine-learned model.

In the case where a value within a text field is not apparent from text extracted from a text portion of the web content, a receiving entity may be deduced based on factors such as article source name, email associated with article domain, article source geographic location, publication date, and other components relative to the article source. The extracted REE is mapped to either an existing unique receiving entity identifier or a generated unique receiving entity identifier assigned to the receiving entity within the web content. For example, if an article entitled “Major Changes to Come with new $100 k investment” is published on ExampleStartUpCo's website and there is no receiving entity apparent from the text, then ExampleStartUPCo may be construed as the receiving entity extracted from the article and ExampleStartUPCo is mapped to a unique entity identifier. REE analyzer tool 102 is able to make deductions and inferences to identify feature values based on the source, topics, and context within web content that are not apparent from web content.

At block 210, an inventory check is performed on server 114 or other entity database to determine whether the REE extracted from the text portion of the web content already exists. The inventory check is based on existing records for a REE associated with unique entity identifiers. In situations where a REE is extracted from more than one (e.g., news) source and a version of the REE already exists in server 114, multiple versions of the REE are grouped together based on their shared unique entity identifier. The grouping of multiple versions of the REE may also be based on the investment amount, publication date, URL, geographic location, or the combination of receiving entity name and date.

If no record exists for an REE, then block 212 occurs where the REE record containing the associated unique entity identifier is stored. If the REE already exists, then block 214 occurs where the multiple versions of the REE are compared and aggregated to produce a version of the REE having most, if not all, relevant fields populated.

In an embodiment, where there are one or more existing versions of an REE and various fields are either missing or not extractable from web content, the versions along with the contextual data may be used to form a complete REE. For example, if a first news article reads “Microsoft Makes Big Investment in NewStartUpCo” and a second news article reads “NewStartUpCo Making History With New Capital”, REE analyzer tool 102 is able to use the extractable from both articles in addition to data such as the URL, geo-location of the article's publisher, and other factors to generate a complete REE.

In an embodiment, a validation process is performed that checks for distinctions between the sources of the web content and the REE record in order to verify that the content in the REE record is accurate.

### Label Generation

Training data includes multiple training instances, each corresponding to a different text portion found in one or more content items from one or more (e.g., third party) data sources. Each training instance includes a label indicating whether the corresponding text portion indicates an REE. During the training phase, a machine-learned model captures the correlation between features and labels. The correlation is reflected, at least in part, in the weight or coefficient learned for each feature.

The type of label used in training data indicates the type of machine-learned model. For example, a label may be 0 or 1:1 indicating a presence of a REE and 0 indicating no presence of a REE. Thus, a machine-learned model generated using such label data is a binary classification model. Even though the machine-learned model may be a classification model, the machine-learned model may still output a continuous value; however, a threshold value may be defined such that an output value above that threshold value is considered to be in one class (e.g., an REE) and an output value below that threshold value is considered to be in another class (e.g., not an REE).

Feature value calculator 320 may generate multiple sets of training data 330, where each set is used to train or validate the REE classification model. For example, as described in more detail below, one part of training data 330 may be used to train a classification model for content items from a first data source and another part of training data 330 may be used to train another classification model for content items from a second data source. The different sets of training data may be based on different features. Thus, one set of training data may have more features than another set of training data, but some of the features used for both training sets may be the same.

Modeler 340 implements one or more machine learning techniques to generate a REE classification model based on training data 330, or at least a portion thereof. One machine learning technique involves generating random values for initial coefficient values for the features. The random values may be constrained to a certain range, such as between 0 and 1 or between −10 and 10.

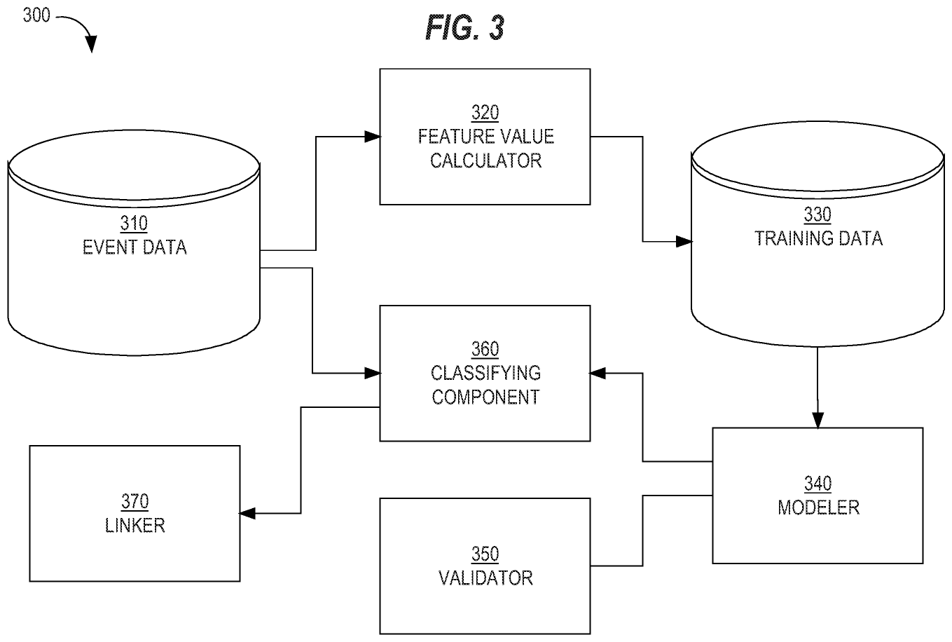

Validator 350 validates the generated REE classification model using a portion of training data 330, that was not used to train the REE classification model. Validator 350 determines, given a particular p-cutoff, a precision rate and a recall rate of the classification model. If the precision rate or recall rate is less than a particular threshold, then classifying component 360 is used to classify web content whose data may be reflected in event data 310 or whose data may be stored separately. For example, feature value calculator 320 may (1) generate feature values based on data about event items (e.g., reflected in event data 310, as depicted in FIG. 3) that are to be classified and (2) store the feature values for that event data in storage to which classifying component 360 has access. Alternatively, instead of a pull model approach where classifying component 360 retrieves the feature values from storage, feature value calculator 320 may transmit (“push”) the feature values to classifying component 360 for classifying the feature values.

### Different Classification Models

In an embodiment, multiple REE classification models (whether rule-based or machine-learned) are constructed. Web content may be classified based on different criteria within the article, such as type of attribute (article title, URL, media content). One reason for constructing different REE classification models for different sets of web content is because some features may be applicable to some set or class of web content but not other sets or classes. For example, one source for a specific REE classification model may comprise metadata or annotations associated with portions of a first web content, and a different source for the same REE may utilize a distinct classification model able to extract distinct information pertaining to the REE based off of portions of a second web content.

Another reason for constructing different REE classification models is because different types of web content may have different structure and formatting and/or different type/variety of content. For example, a first classification model is trained based on training data from a first third party data source while another classification model is trained based on training data from a second third party data source. Then, when a content item from the first data source is added to database 110, multiple feature values are extracted from each of one or more text portions from the content item and input into the first classification model. Similarly, when a content item from the second data source is added to database 110, multiple feature values are extracted from each of one or more text portions from the content item and input into the second classification model.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

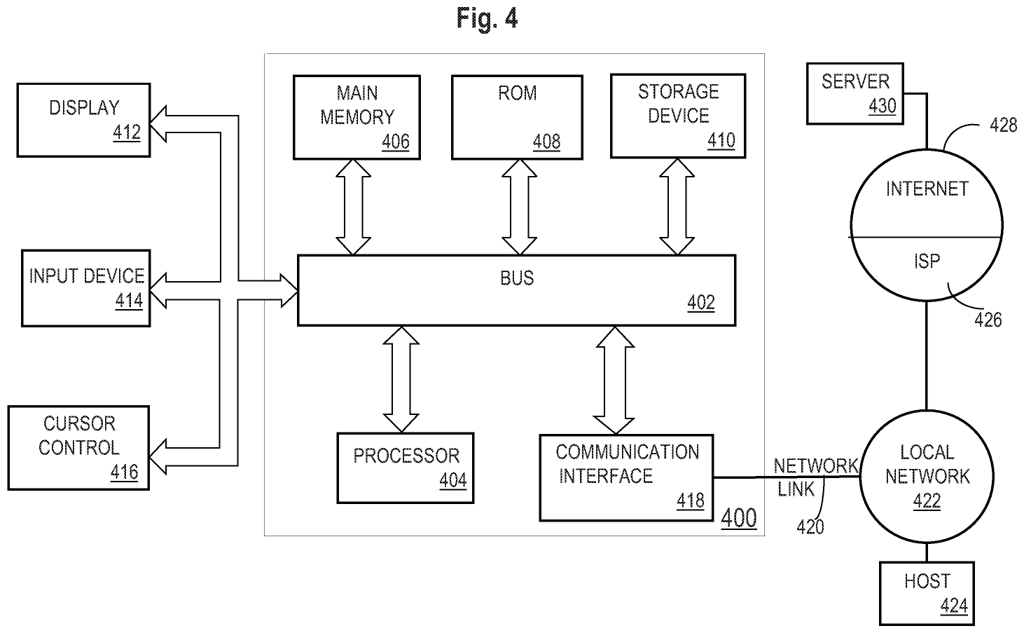

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 514, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
storing training data that comprises a plurality of training instances, each of which includes a plurality of feature values and a label that indicates whether the training instance pertains to an event of a particular type;
using one or more machine learning techniques to train a classification model based on the training data;
identifying a first plurality of feature values of a sequence of tokens associated with web content;
based on the first plurality of feature values, determining whether the sequence of tokens pertains to an event of the particular type;
wherein determining comprises inserting the first plurality of feature values into the classification model that generates an output that indicates whether the sequence of tokens pertains to an event of the particular type;
in response to determining that the sequence of tokens pertains to an event of the particular type, extracting, from the sequence of tokens, a plurality of data items that includes an indication of a receiving entity and a quantity;
storing, in a record, the indication of the receiving entity and the quantity associated with the event;
wherein the method is performed by one or more computing devices.

2. The method of claim 1, further comprising:
analyzing the sequence of tokens for one or more term frequency values indicative of a number of occurrences of a n-gram in the sequence of tokens;
wherein the first plurality of feature values includes the one or more term frequency values.

3. The method of claim 1, further comprising:
after determining that the sequence of tokens pertains to the event of the particular type, identifying a name of the receiving entity;
determining that a plurality of entities in an entity database share the same name, wherein each entity of the plurality of entities is associated with a different unique identifier;
determining, based on one or more criteria, a particular unique identifier for the receiving entity;
wherein storing the indication of receiving entity in the record comprises storing the particular unique identifier of the receiving entity in the record.

4. The method of claim 3, wherein the one or more criteria include a uniform resource locator (URL) associated with the web content, a stock symbol associated with the web content, a geographic location associated with the web content, or based on a domain name associated with the web content.

5. A method comprising:
identifying a first plurality of feature values of a sequence of tokens associated with web content;
based on the first plurality of feature values, determining whether the sequence of tokens pertains to an event of a particular type;
in response to determining that the sequence of tokens pertains to an event of the particular type, extracting, from the sequence of tokens, a plurality of data items that includes an indication of a receiving entity and a quantity;
storing, in a record, the indication of the receiving entity, the quantity, and a date associated with the event;
wherein the method is performed by one or more computing devices.

6. The method of claim 5, further comprising:
storing training data that comprises a plurality of training instances, each of which includes a second plurality of feature values and a label that indicates whether the training instance pertains to an event of the particular type;
using one or more machine learning techniques to train a classification model based on the training data;
wherein making the determination comprises inserting the first plurality of feature values into the classification model that generates an output that indicates whether the sequence of tokens pertains to an event of the particular type.

7. The method of claim 5, further comprising:
analyzing the sequence of tokens for one or more term frequency values indicative of a number of occurrences of a n-gram in the sequence of tokens;
inserting the one or more term frequency values into the classification model.

8. The method of claim 5, further comprising:
after determining that the sequence of tokens pertains to an event of the particular type, determining, based on the sequence of tokens, a round type associated with the receiving entity event;
storing the round type in the record.

9. The method of claim 5, further comprising:
after determining that the sequence of tokens pertains to an event of the particular type, identifying a name of the receiving entity;
determining that a plurality of entities in an entity database share the same name, wherein each entity of the plurality of entities is associated with a different unique identifier;
determining, based on a uniform resource locator (URL) associated with the web content, a particular unique identifier for the receiving entity;
wherein storing the indication of receiving entity in the record comprises storing the particular unique identifier of the receiving entity in the record.

10. The method of claim 5, further comprising:
after determining that the sequence of tokens pertains to an event of the particular type, identifying a name of the receiving entity;
determining that a plurality of entities in an entity database share the same name, wherein each entity of the plurality of entities is associated with a different unique identifier;
determining, based on a stock symbol associated with the web content, a particular unique identifier for the receiving entity;
wherein storing the indication of receiving entity in the record comprises storing the particular unique identifier of the receiving entity in the record.

11. The method of claim 5, further comprising:
after determining that the sequence of tokens pertains to an event of the particular type, identifying a name of the receiving entity;
determining that a plurality of entities in an entity database share the same name, wherein each entity of the plurality of entities is associated with a different unique identifier;
determining, based on a geographic location associated with the web content, a particular unique identifier for the receiving entity;
wherein storing the indication of receiving entity in the record comprises storing the particular unique identifier of the receiving entity in the record.

12. The method of claim 5, further comprising:
after determining that the sequence of tokens pertains to an event of the particular type, identifying a name of the receiving entity;
determining that a plurality of entities in an entity database share the same entity name, wherein each entity of the plurality of entities is associated with a different unique identifier;
determining, based on a domain name associated with the web content, a particular unique identifier for the receiving entity;
wherein storing the indication of the receiving entity in the record comprises storing the particular unique identifier of the receiving entity in the record.

13. One or more storage media storing instructions which, when executed by one or more processors, cause:
identifying a first plurality of feature values of a sequence of tokens associated with web content;
based on the first plurality of feature values, determining whether the sequence of tokens pertains to an event of a particular type;
in response to determining that the sequence of tokens pertains to an event of the particular type, extracting, from the sequence of tokens, a plurality of data items that includes an indication of a receiving entity and a quantity;
storing, in a record, the indication of the receiving entity, the quantity, and a date associated with the event.

14. The one or more storage media of claim 13, wherein the instructions, when executed by the one or more processors, further cause:
storing training data that comprises a plurality of training instances, each of which includes a second plurality of feature values and a label that indicates whether the training instance pertains to an event of the particular type;
using one or more machine learning techniques to train a classification model based on the training data;
wherein making the determination comprises inserting the first plurality of feature values into the classification model that generates an output that indicates whether the sequence of tokens pertains to an event of the particular type.

15. The one or more storage media of claim 13, wherein the instructions, when executed by the one or more processors, further cause:
analyzing the sequence of tokens for one or more term frequency values indicative of a number of occurrences of a n-gram in the sequence of tokens;
inserting the one or more term frequency values into the classification model.

16. The one or more storage media of claim 13, wherein the instructions, when executed by the one or more processors, further cause:
after determining that the sequence of tokens pertains to an event of the particular type, determining, based on the sequence of tokens, a round type associated with the receiving entity event;
storing the round type in the record.

17. The one or more storage media of claim 13, wherein the instructions, when executed by the one or more processors, further cause:
after determining that the sequence of tokens pertains to an event of the particular type, identifying a name of the receiving entity;
determining that a plurality of entities in an entity database share the same name, wherein each entity of the plurality of entities is associated with a different unique identifier;
determining, based on a uniform resource locator (URL) associated with the web content, a particular unique identifier for the receiving entity;
wherein storing the indication of receiving entity in the record comprises storing the particular unique identifier of the receiving entity in the record.

18. The one or more storage media of claim 13, wherein the instructions, when executed by the one or more processors, further cause:
after determining that the sequence of tokens pertains to an event of the particular type, identifying a name of the receiving entity;
determining that a plurality of entities in an entity database share the same name, wherein each entity of the plurality of entities is associated with a different unique identifier;
determining, based on a stock symbol associated with the web content, a particular unique identifier for the receiving entity;
wherein storing the indication of receiving entity in the record comprises storing the particular unique identifier of the receiving entity in the record.

19. The one or more storage media of claim 13, wherein the instructions, when executed by the one or more processors, further cause:
after determining that the sequence of tokens pertains to an event of the particular type, identifying a name of the receiving entity;
determining that a plurality of entities in an entity database share the same name, wherein each entity of the plurality of entities is associated with a different unique identifier;
determining, based on a geographic location associated with the web content, a particular unique identifier for the receiving entity;
wherein storing the indication of receiving entity in the record comprises storing the particular unique identifier of the receiving entity in the record.

20. The one or more storage media of claim 13, wherein the instructions, when executed by the one or more processors, further cause:
after determining that the sequence of tokens pertains to an event of the particular type, identifying a name of the receiving entity;
determining that a plurality of entities in an entity database share the same entity name, wherein each entity of the plurality of entities is associated with a different unique identifier;
determining, based on a domain name associated with the web content, a particular unique identifier for the receiving entity;
wherein storing the indication of receiving entity in the record comprises storing the particular unique identifier of the receiving entity in the record.
